(19) United States
(12) Patent Application Publication
(10) Pub. No.: US 2024/0362663 A1
(43) Pub. Date: Oct. 31, 2024

(54) DEMONSTRATION EXPERIMENT MANAGEMENT SYSTEM

(71) Applicant: TOYOTA JIDOSHA KABUSHIKI KAISHA, Toyota-shi (JP)

(72) Inventors: Yusuke KIDA, Tokyo-to (JP); Nobuhisa OTSUKI, Tokyo-to (JP); Daichi YAMASHITA, Nishitokyo-shi (JP); Kenta TAKESHIMA, Tokyo-to (JP); Hideo HASEGAWA, Nagoya-shi (JP)

(73) Assignee: TOYOTA JIDOSHA KABUSHIKI KAISHA, Toyota-shi (JP)

(21) Appl. No.: 18/597,540

(22) Filed: Mar. 6, 2024

(30) Foreign Application Priority Data
Apr. 28, 2023 (JP) 2023-074488

(51) Int. Cl. G06Q 30/0217

(52) U.S. Cl. CPC G06Q 30/0217

(57) ABSTRACT

The present disclosure relates to a demonstration experiment management system for managing a demonstration experiment. The demonstration experiment management system includes processing circuitry. The processing circuitry acquires information on a consent item of which a participant of the demonstration experiment consents to provide data among a request item. The request item is an item of which an executor of the demonstration experiment requests the participant to provide the data. Then, the processing circuitry calculates a contribution degree of the participant to the demonstration experiment based on at least the consent item. Then, the processing circuitry determines an incentive to be paid to the participant by the executor based on at least the contribution degree.

### CROSS-REFERENCE TO RELATED APPLICATION

The present application claims priority under 35 U.S.C. § 119 to Japanese Patent Application No. 2023-074488, filed on Apr. 28, 2023, the contents of which application are incorporated herein by reference in their entirety.

### BACKGROUND

### Field

The present disclosure relates to a demonstration experiment management system which manages a demonstration experiment.

### Background Art

JP2016-509307A discloses an apparatus and method for planning a data market experiment under a predetermined budget. The data market experiment has many applications including medical test, market research, online research, or the like.

As documents indicating a technical level at the time of filing in the technical field of the present disclosure or in a technical field related thereto, JP2006-004324A and JP5515781 can be exemplified in addition to JP2016-509307A.

### SUMMARY

A demonstration experiment is known as one of methods for verifying effectiveness when putting a new product or a technique into practical use. The demonstration experiment is an experiment performed by using the product or the technique in an actual scene. It is desirable for an executor of the demonstration experiment that he/she can obtain data of many participants by performing the demonstration experiment in order to perform accurate verification. Thus, it is considered to give an incentive to each participant to motivate him/her to participate in the demonstration experiment. If the incentive can be made appropriate in accordance with a contribution degree of each participant to the demonstration experiment, a motivation of the participant to participate in the demonstration experiment can be raised.

An object of the present disclosure is to provide a technique capable of giving an appropriate incentive to a participant of a demonstration experiment in accordance with a contribution degree to the demonstration experiment.

The present disclosure relates to a demonstration experiment management system for managing a demonstration experiment. The demonstration experiment management system includes processing circuitry. The processing circuitry acquires information on a consent item of which a participant of the demonstration experiment consents to provide data among a request item. The request item is an item of which an executor of the demonstration experiment requests the participant to provide the data. Then, the processing circuitry calculates a contribution degree of the participant to the demonstration experiment based on at least the consent item. Then, the processing circuitry determines an incentive to be paid to the participant by the executor based on at least the contribution degree.

According to the present disclosure, the contribution degree of the participant to the demonstration experiment is calculated and the incentive to be paid to the participant is determined based on the calculated contribution degree. The contribution degree is calculated based on at least the consent item of which the participant consents to provide the data.

The data which the participant consents to provide is utilized by the executor. That is, the participant contributes to the demonstration experiment by providing the data related to himself/herself. Further, it is unique to the demonstration experiment that the executor acquires the data after obtaining the consent of the participant for each item. Therefore, by calculating the contribution degree based on the information on the consent item, it is possible to evaluate the contribution degree appropriately in consideration of characteristics of the demonstration experiment. By determining the incentive based on the contribution degree calculated in this way, an appropriate incentive can be given to the participant.

### BRIEF DESCRIPTION OF THE DRAWINGS

FIG. 1 is a conceptual diagram showing an example of a configuration of a demonstration experiment management system according to a present embodiment.

FIG. 2 is a table showing an example of data acquired by a management apparatus according to the present embodiment in a demonstration experiment.

FIG. 3 is a diagram for explaining the demonstration experiment management system according to a first embodiment.

FIG. 4 is a diagram for explaining the demonstration experiment management system according to a second embodiment.

FIG. 5 is a table showing another example of information included in a database in the second embodiment.

### DETAILED DESCRIPTION

Embodiments of the present disclosure will be described with reference to the accompanying drawings.

### 1. Overview of Demonstration Experiment Management System

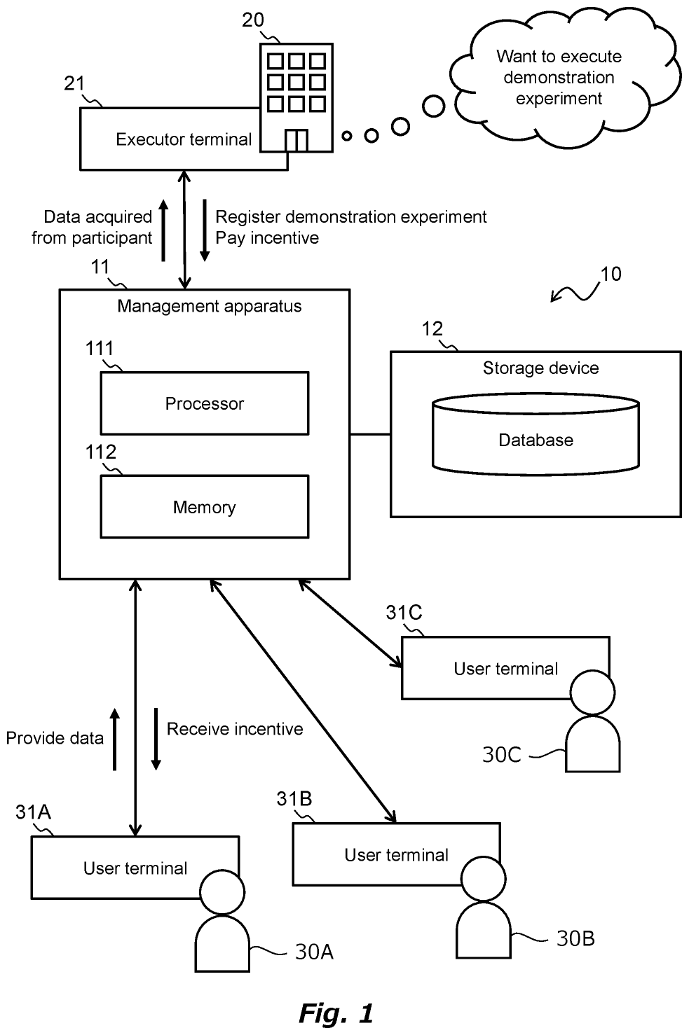

FIG. 1 is a conceptual diagram showing an example of the configuration of a demonstration experiment management system 10 for managing demonstration experiments. The demonstration experiment management system 10 includes a management apparatus 11 and a storage device 12 coupled to the management apparatus 11.

The management apparatus 11 is a server that manages a demonstration experiment. The management apparatus 11 includes one or more processors 111 (hereinafter, simply referred to as a processor 111 or processing circuitry 111) and one or more memories 112 (hereinafter, simply referred to as a memory 112). The processor 111 executes various processes. The functions of the management apparatus 11 are implemented by the processing executed by the processor 111. The memory 112 is a volatile memory such as a DDR memory, and develops a program used by the processor 111 and temporarily stores various data.

The storage device 12 is a non-volatile storage media such as a flash memory or a hard disk drive (HDD). The storage device 12 stores various programs and various data necessary for the management of the demonstration experiment by the management apparatus 11. The various data stored in the storage device 12 includes a database described later. The storage device 12 may be provided in plural. The storage device 12 may be included in the management apparatus 11.

The management apparatus 11 can communicate with an executor terminal 21 owned by an executor 20 of the demonstration experiment. The number of the executers 20 and the number of the executor terminals 21 may be plural. The executor 20 registers a demonstration experiment desired to be executed in the management apparatus 11. The executor 20 transmits information necessary for performing the demonstration experiment to the management apparatus 11. For example, the executor 20 transmits information about the contents of the demonstration experiment, the desired date and time, the data desired to be acquired, and the like to the management apparatus 11. The executor 20 transmits and receives these pieces of information to and from the management apparatus 11 through the executor terminal 21.

The management apparatus 11 can communicate with user terminals 30A, 30B, and 30C owned by a plurality of users 31A, 31B, and 31C of the demonstration experiment management system 10. Hereinafter, as reference numerals indicating participants, reference numerals 30A, 30B, and 30C are used to specify one participant, but reference numeral 30 is used to indicate any participant and to collectively refer to the participants. In addition, as reference numerals indicating participant terminals, reference numerals 31A, 31B, and 31C are used when one is specified, but reference numeral 31 is used when any participant terminals are indicated or when the participant terminals are collectively referred to.

When a new demonstration experiment is registered in the management apparatus 11 by the executor 20, the management apparatus 11 notifies the user 30 of information on the demonstration experiment through the user terminal 31. When the user 30 wants to participate in the reported demonstration experiment, the user 30 registers information necessary for the participation in the management apparatus 11 through the user terminal 31. If the recruitment condition of the executor 20 and the condition of the user 30 match, the participation of the user 30 in the demonstration experiment is determined.

The user 30 who has become a participant of the demonstration experiment provides data related to the user 30 to the executor 20 in the demonstration experiment. Data related to the user 30 is first acquired by the management apparatus 11 from a terminal device such as the user terminal 31. Then, the management apparatus 11 transmits the acquired data to the executor terminal 21, and the data is provided to the executor 20. The data transmitted from the management apparatus 11 to the executor terminal 21 may be data itself acquired from the terminal device or may be data subjected to processing such as data aggregation.

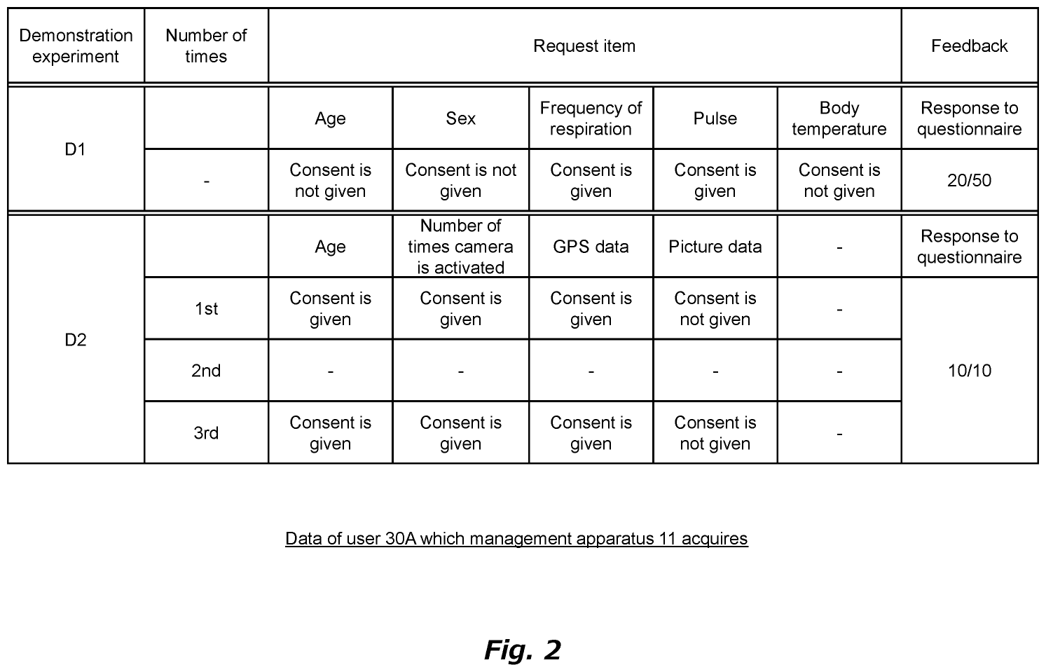

FIG. 2 is a table for explaining an example of information relating to a participant (here, the user 30A), which is acquired by the management apparatus 11 at the time of the demonstration experiment.

The request item is an item for the executor 20 to request the participant of the demonstration experiment to provide data. The participant of the demonstration experiment can select whether or not to provide data to the executor 20 for each request item. Hereinafter, among the request items, an item for which the participant of the demonstration experiment agrees to provide data is referred to as a consent item. The data of the participant for the participant item is acquired by the management apparatus 11 through the terminal device. At this time, the management apparatus 11 does not acquire data of the participant for the item for which the agreement has not been obtained. Thus, the data of the participants are collected by the management apparatus 11 while considering the privacy of the participants.

For example, the executor 20 is requesting to provide information on the ages, genders, respiratory rates, pulse rates, and body temperatures of the participants in the demonstration D1. The user 30A agrees to provide information about the respiration rate and the pulse. Therefore, the management apparatus 11 acquires the respiration rate and the pulse of the user 30A, but does not acquire the age, the sex, and the body temperature.

The executor 20 may also ask the participant for feedback about the demonstration experiment. The feedback from the participants is made voluntarily by the participants in response to a request from the executor 20. An example of the feedback is an answer to a questionnaire. The questionnaire is conducted by the management apparatus 11 based on a request from the executor 20. For example, in the demonstration D1, a questionnaire consisting of 50 questions is conducted by the management apparatus 11, and the user 30A answers 20 questions. The answer is input to the user device 31A by the user 30A and is acquired by the management apparatus 11.

Each demonstration experiment may be performed a plurality of times, and in this case, the participant may be able to select participation or non-participation for each time. For example, the demonstration D2 is performed three times, and the user 30A participates in the first and third times, but does not participate in the second time.

Reference is made again to FIG. 1. For the executor 20, in order to reduce the bias of data and make the demonstration experiment meaningful, it is desirable that the number of users 30 who wish to participate in the demonstration experiment is large, and it is desirable that the amount of information that can be acquired from each participant is large. Therefore, as motivation for the user 30 to participate in the demonstration experiment and to provide data, an incentive is given to the user 30 who has participated in the demonstration experiment. The incentive may be given to the participant directly from the executor 20 or may be given to the participant via the management apparatus 11. The incentive may also be paid in money, corporate currency, etc. However, in general, the payment is often made by goods, services, or the like.

If the incentive paid to the participant can be made appropriate according to the contribution degree of the participant to the demonstration experiment, the user 30 can be more effectively prompted to participate in more demonstration experiments and to provide more data.

Two embodiments of the demonstration experiment management system 10 for giving an appropriate incentive to a participant according to a contribution degree will be described below.

### 2. First Embodiment

In order to pay an appropriate incentive according to the contribution degree, the contribution degree of each participant to the demonstration experiment needs to be appropriately evaluated. Therefore, as a first embodiment, calculation of the contribution degree of the participant by the management apparatus 11 will be described.

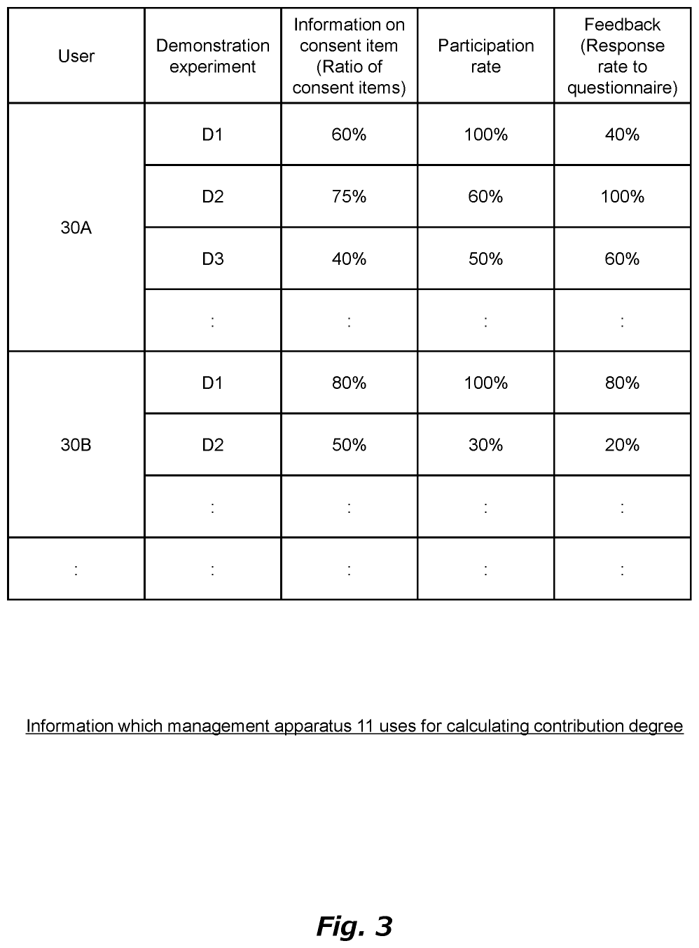

FIG. 3 is a table showing an example of information used by the management apparatus 11 to calculate the contribution degree. In the table of FIG. 3, information, participation rates, and feedback for the respective users 30 with respect to the consent item are shown for each demonstration experiment. The management apparatus 11 can calculate these pieces of information based on data acquired from the terminal device in the demonstration experiment. The management apparatus 11 calculates the contribution degree based on at least one item of the information.

Here, the ratio of the consent item is used as the information on the consent item. The ratio of the consent item is the ratio of the consent item to the request item in each demonstration experiment. For example, in the demonstration D1, the user 30A agrees to provide three items of five request items. Therefore, the ratio of the consent item is calculated as 60%.

When calculating the contribution degree based on the ratio of the participant items, the management apparatus 11 calculates the contribution degree such that the contribution degree increases as the ratio of the participant items increases.

The management apparatus 11 may calculate the contribution degree using information other than the ratio of the participant items as the information on the participant items. For example, the management apparatus 11 may calculate the contribution degree based on the number of consent items. In this case, the management apparatus 11 calculates the contribution degree such that the contribution degree increases as the number of the participant items increases.

Alternatively, the management apparatus 11 may calculate the contribution degree based on the type of the consent item. For the executor 20, the importance of acquiring data may vary depending on the type of the request item. In such a case, the contribution degree may be calculated from the number or the ratio of the participant items after weighting each item according to the level of the importance. For example, in the example of the demonstration D1 in FIG. 2, it is more important for the executor 20 to acquire the age and sex than to acquire the respiration rate, the pulse rate, and the body temperature in order to reduce bias in data aggregation. Therefore, the management apparatus 11 may calculate the contribution degree of the participant such that the contribution degree is higher when any one of the age and the gender is included in the participant item than when any one of the breathing rate, the pulse rate, and the body temperature is included in the participant item.

Alternatively, the ease of obtaining consent from the participant may vary depending on the type of request item. For example, in the demonstration D2 of FIG. 2, the participants may have a difficulty in agreeing to provide GPS-data and photograph-data, because they are private information, compared to age and the number of times of activation of the camera. Therefore, the contribution degree may be calculated such that the contribution degree is higher when the GPS data and the picture data are included in the consent item than when the GPS data and the picture data are not included in the consent item.

The method of calculating the contribution degree of the participant to the demonstration experiment based on the information on the participant item is a method of calculating the contribution degree specific to the demonstration experiment. That is, in the demonstration experiment, since the experiment is performed by using a product or a technique in an actual situation, it is necessary to collect data after obtaining the consent of the participants in order to consider the privacy of the participants. This is typical of a demonstration experiment.

The participation rate is a rate at which the user 30 participates in a plurality of demonstration experiments. For example, the demonstration test D2 is performed three times, and the user 30A participates in two of the three times, and thus the participation rate is calculated as 60%. When the contribution degree is calculated based on the participation rate, the management apparatus 11 calculates the contribution degree such that the contribution degree increases as the participation rate increases. Note that, when the demonstration experiment is performed only once, the participation rate may not be calculated or may be calculated as 100%.

The management apparatus 11 may evaluate feedback from the participant and use the evaluation result for the calculation of the contribution degree. Here, the feedback is evaluated by the response rate to the questionnaire. When calculating the contribution degree based on the evaluation of the feedback, the management apparatus 11 calculates the contribution degree such that the contribution degree increases as the evaluation increases. For example, if the feedback from the participant is an answer to a questionnaire, the contribution degree is calculated so that the higher the answer rate, the higher the contribution degree.

The management apparatus 11 may calculate the contribution degree based on information about the participant item among the information. By calculating the contribution degree based on the information about the consent item, it is possible to calculate an appropriate contribution degree based on the characteristics of the demonstration experiment.

Alternatively, the management apparatus 11 may calculate the contribution degree by using all three of the information on the participant item, the participation rate, and the evaluation on the feedback. By calculating the contribution degree based on more information, it is possible to calculate an appropriate contribution degree that is more suitable for the actual situation.

As described above, according to the demonstration experiment management system 10 of the first embodiment, the contribution degree of the participant to the demonstration experiment can be appropriately calculated. By appropriately calculating the contribution degree, the incentive determined based on the contribution degree can also be made appropriate. In this way, an appropriate incentive corresponding to the contribution degree to the demonstration experiment can be paid to the participant, and the effect of the incentive payment as motivation for the user 30 to participate in the demonstration experiment and to provide data can be enhanced.

The incentive based on the calculated contribution degree can be arbitrarily determined. For example, the contribution degree calculated by the management apparatus 11 may be reflected in the amount of incentive given to the participant. For example, it is assumed that one juice is paid as an incentive to a participant having a low contribution degree, and three juices are paid as incentives to a participant having a high contribution degree.

Alternatively, the calculated contribution degree may be reflected in the type of incentive to be given. For example, it is assumed that a general coffee beverage which is widely distributed in the market is paid as an incentive to a participant having a low contribution degree, and a coffee beverage of the original blend is paid as an incentive to a participant having a high contribution degree. Alternatively, an incentive with a high appropriateness degree may be paid to a participant with a high contribution degree and an incentive with a low appropriateness degree may be paid to a participant with a low contribution degree by using information on the appropriateness degree of the incentive described later. The appropriateness degree of the incentive will be described in the second embodiment.

The incentive paid to the participant may be determined by the management apparatus 11. In this case, the management apparatus 11 may notify the executor 20 of information about the determined incentive. Alternatively, executor 20 may determine the incentive to pay the participant. In this case, the management apparatus 11 transmits information on the calculated contribution degree to the executor 20 through the executor terminal 21. The executor 20 may determine an incentive based on the contribution degree of the participant acquired from the management apparatus 11.

### 3. Second Embodiment

In order to give an appropriate incentive corresponding to the contribution degree to the user 30, it is more effective to know an incentive that matches the needs of the participant. Therefore, as a second embodiment, construction of a database related to the appropriateness degree of an incentive by the demonstration experiment management system 10 will be described. The second embodiment is an embodiment in which an incentive is paid by an object or a service.

The management apparatus 11 can receive an evaluation from the participant for the incentive paid in the demonstration experiment. The user 30 who participates in the demonstration experiment and receives the incentive inputs evaluation to the user terminal 31, and the management apparatus 11 communicates with the user terminal 31 to acquire the input evaluation. Then, the management apparatus 11 constructs a database for the appropriateness degree of the incentive based on the acquired evaluation. The constructed database is stored in the storage device 12.

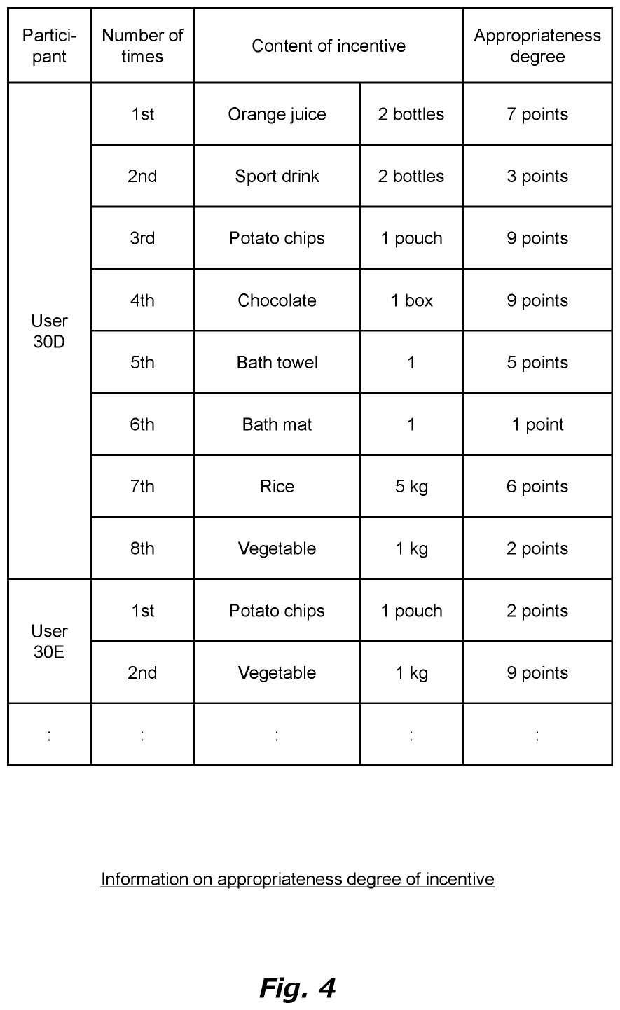

FIG. 4 is a table showing an example of information about the appropriateness degree of an incentive, which is included in the database to be constructed. In the table of FIG. 4, the contents of the incentives paid in the past and the appropriateness degree of each incentive are shown for each user 30.

Here, the appropriateness degree is calculated as a score, and a higher score means a higher appropriateness degree. When the management apparatus 11 constructs the database, the management apparatus 11 determines incentives for the respective participants so that as many kinds of incentives as possible are paid to the respective participants. At this time, as shown in FIG. 4, different incentives may be given one by one in each of the plurality of demonstration experiments. Alternatively, the incentive may be determined so that a plurality of types of incentives are given in one demonstration experiment. The management apparatus 11 receives the evaluation of each incentive from the participant, and calculates the appropriateness degree so that the higher the evaluation of the incentive, the higher the appropriateness degree. As an example of the calculation of the appropriateness degree, when the evaluation from the participant is given as a score, the evaluation given by the participant may be used as the appropriateness degree as it is.

Information on the appropriateness degree of the incentive calculated in this way is stored in the storage device 12 as a database. The database stored in the storage device 12 can be used to help determine incentives to pay for participants in subsequent demonstration experiments.

For example, assume that after the database is constructed, the user 30D participates in a new demonstration experiment. The management apparatus 11 acquires information about the appropriateness degree of the incentive to be paid to the user 30D from the database. The appropriateness degree of the incentive for the user 30D is particularly high for potato chips and chocolates. This means that the user 30D particularly likes potato chips and chocolates as incentives. Therefore, the management apparatus 11 determines these as incentives to be newly paid to the user 30D. The same applies to a case where the user 30 other than the user 30D participates in a new demonstration experiment. In this way, an incentive that matches the needs of each participant can be given, and the degree of satisfaction of the participant with the received incentive can be increased.

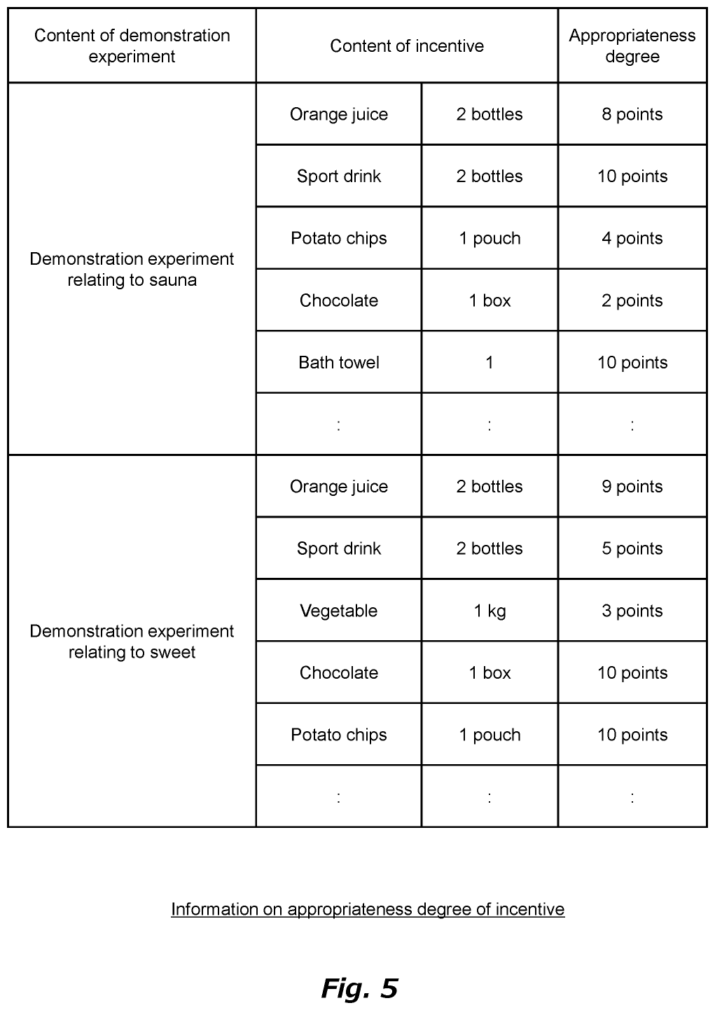

As another example of the information on the appropriateness degree of the incentive included in the database, the appropriateness degree of each incentive may be calculated for each content of the demonstration experiment, not for each user 30. FIG. 5 is a table showing another example of information about the appropriateness degree of an incentive.

Participants who participate in the demonstration experiment of the same content may show similar tendencies in the preference of the object or the service. For example, participants in a demonstration study on sauna may generally prefer sports drinks over orange juice, whereas participants in a demonstration study on confectionary may generally prefer orange juice over sports drinks. Therefore, the management apparatus 11 may construct information on the appropriateness degree of the incentive calculated for each content of the demonstration experiment as a database as shown in FIG. 5.

In this case, the management apparatus 11 prepares a plurality of kinds of incentives in advance and gives them to the participants of the demonstration experiment at random. The management apparatus 11 then aggregates the evaluation of the incentive from the participants for each type of incentive, and calculates the appropriateness degree so that the higher the evaluation of the incentive from the participants, the higher the appropriateness degree. For example, the average value of the evaluations of the participants for each incentive may be set as the appropriateness degree.

The database thus constructed is stored in the storage device 12, and can be used for determining incentives in a subsequent demonstration experiment.

For example, as incentives in a demonstration experiment regarding sauna, the appropriateness degree of sports drinks and bath towels is particularly high. This means that the user 30 who wants to participate in the demonstration experiment related to sauna tends to prefer sports drinks and bath towels as incentives. Therefore, the management apparatus 11 determines these as incentives. In this way, an incentive that matches the needs of the user 30 can be paid, and the degree of satisfaction of the participant who has received the incentive can be increased.

In addition, when the incentive is paid by goods or services, the provision of the incentive may also serve as an advertisement of the product. Therefore, the executor 20 may request the cooperation partner company to pay the incentive. In this case, the information on the appropriateness degree of the incentive as shown in FIG. 5 can be used to search for a company to cooperate with. For example, assume that the executor 20 of the demonstration experiment on sauna is considering asking a confectionery maker or a beverage maker to cooperate. According to the information in FIG. 5, the appropriateness degree as an incentive for the participants of the demonstration experiment regarding sauna is higher for orange juice and sports drinks than for potato chips and chocolate. Therefore, the executor 20 selects the beverage maker as a company to which cooperation is requested. The beverage maker has an advantage that the beverage maker can distribute the product of the beverage maker to the user 30 who is highly likely to prefer the product of the beverage maker, and thus the beverage maker is highly likely to cooperate with the user 30.

The database to be constructed may further include information calculated as follows. The management apparatus 11 may calculate the appropriateness degree of the incentive for each of the smaller sections in addition to the contents of the demonstration experiment. For example, the management apparatus 11 may calculate the appropriateness degree of the incentive for each attribute of the participant such as age and gender. The information calculated in this way can also be used when determining incentives to be paid to participants in a subsequent demonstration experiment. This makes it possible to determine an incentive with a higher appropriateness degree in accordance with the attribute of the participant, and to make the incentive more suitable for the needs of the participant.

In both cases where the information on the appropriateness degree of the incentive is information for each participant and information for each content of the demonstration experiment, the entity that determines the incentive using the database stored in the storage device 12 may be the management apparatus 11 or the executor 20. When the executor 20 is the decision subject, the management apparatus 11 provides the executor 20 with a part or all of the constructed information, and the executor 20 decides the incentive based on the provided information.

As described above, according to the demonstration experiment management system 10 of the second embodiment, the evaluation of the paid incentive from the participant is received, and the appropriateness degree of the incentive is calculated based on the received evaluation. Then, information on the calculated appropriateness degree of the incentive is constructed as a database. The database can be used by the management apparatus 11 or the executor 20 to help make the incentive appropriate for the needs of the participant. In this way, it is possible to increase the motivation of the user 30 to participate in the demonstration experiment and to increase the effect of giving the incentive as the motivation of the user 30 to participate in the demonstration experiment.

What is claimed is:

1. A demonstration experiment management system for managing a demonstration experiment, the demonstration experiment management system comprising processing circuitry, wherein
a request item is an item of which an executor of the demonstration experiment requests a participant of the demonstration experiment to provide data, and
the processing circuitry is configured to:
acquire information on a consent item of which the participant consents to provide the data among the request item;
calculate a contribution degree of the participant to the demonstration experiment based on at least the consent item; and
determine an incentive to be paid to the participant by the executor based on at least the contribution degree.

2. The demonstration experiment management system according to claim 1, wherein the processing circuitry is further configured to calculate the contribution degree based on at least one of a number of the consent item, a type of the consent item, and a ratio of the consent item to the request item.

3. The demonstration experiment management system according to claim 1, wherein the processing circuitry is further configured to calculate the contribution degree based on at least one of feedback from the participant to the executor and a participation rate of the participant to the demonstration experiment.

4. The demonstration experiment management system according to claim 1 further comprising one or more storage devices configured to store a database indicating an appropriateness degree of the incentive for each of the participant or for each type of the demonstration experiment, wherein the processing circuitry is further configured to acquire the appropriateness degree from the database and determine the incentive based on the acquired appropriateness degree and the contribution degree.

5. The demonstration experiment management system according to claim 4, wherein the processing circuitry is further configured to:
accept an evaluation for the incentive from the participant;
calculate the appropriateness degree based on the evaluation from the participant for the incentive previously paid to the participant; and
generate or update the database based on the calculated appropriateness degree.
